(19) United States
(12) Patent Application Publication
(10) Pub. No.: US 2020/0101656 A1
(43) Pub. Date: Apr. 2, 2020

(54) MOLDS FOR MAKING INSULATION PRODUCTS

(71) Applicant: JOHNS MANVILLE, Denver, CO (US)

(72) Inventors: Ralph Michael Fay, Lakewood, CO (US); Andrew Pfefer, Aurora, CO (US); Stanislav Kukatin, Centennial, CO (US); Guodong Zheng, Highlands Ranch, CO (US)

(21) Appl. No.: 16/149,314

(22) Filed: Oct. 2, 2018

(51) Int. Cl. B29C 51/02; B29C 51/14; B29C 53/04; B29C 51/00; B29C 51/08; B29C 51/38; B29C 51/30

(52) U.S. Cl. CPC B29C 51/02; B29C 51/14; B29C 53/04; B32B 37/16; B29C 51/082; B29C 51/38; B29C 51/306; B29C 51/004

(57) ABSTRACT

Molds for forming fiber reinforced insulation and methods of using the molds are described. One exemplary mold may include an upper mold and a lower mold. The upper mold and the lower mold may be coupleable to define a mold cavity for receiving therein a fiber reinforced insulation preform. The upper mold may include a plurality of apertures that may be configured to allow moisture from the fiber reinforced insulation preform to pass through the upper mold while substantially preventing fibers from the fiber reinforced insulation preform from passing through the upper mold such that the fiber reinforced insulation preform dries and cures to form the fiber reinforced insulation product. The plurality of apertures may collectively define an open area of at least 20% of an inner surface area of the upper mold that may contact the fiber reinforced insulation preform.

### BACKGROUND OF THE INVENTION

This invention relates generally to molds for making insulation products.

### BRIEF DESCRIPTION OF THE INVENTION

Described below are various insulation products and various molds, systems, and methods for forming the insulation products.

In some embodiments, a two-piece or nested mold design where a perforated inner mold for drying/curing and a matching outer mold for pressing and molding may be implemented. Only the inner perforated mold is put into the drying and curing oven, which can significantly reduce drying/curing time of the insulation in comparison with conventional molds. The inner perforated mold can be configured or adapted to be used with existing molds for quick production of the insulation products. The two-piece or nested mold design reduces insulation production costs as well as mold manufacturing cost.

In some embodiments, an exemplary mold for forming a fiber reinforced insulation product may include an upper mold and a lower mold. The upper mold and the lower mold may be coupleable to define a mold cavity for receiving therein a fiber reinforced insulation preform. The upper mold may include a plurality of apertures that may be configured to allow moisture from the fiber reinforced insulation preform to pass through the upper mold while substantially preventing fibers from the fiber reinforced insulation preform from passing through the upper mold such that the fiber reinforced insulation preform dries and cures to form the fiber reinforced insulation product. The plurality of apertures may collectively define an open area of at least 20% of an inner surface area of the upper mold that contacts the fiber reinforced insulation preform.

In some embodiments, an exemplary mold assembly for making a fiber reinforced insulation product may include an outer mold and an inner mold. The outer mold defines a first mold cavity. The inner mold may be configured to be removably received inside the first mold cavity. The inner mold defines a second mold cavity configured to receive a fiber reinforced insulation preform having a first shape. The inner mold may be configured to surround substantially all sides of the fiber reinforced insulation preform so as to form the fiber reinforced insulation preform into a second shape. When the inner mold is received inside the outer mold, an inner surface of the outer mold may be configured to contact substantially an entire outer surface of the inner mold so as to impart pressure onto the inner mold. The inner mold may be configured to impart the pressure imparted by the outer mold onto the fiber reinforced insulation preform received inside the second mold cavity to form the fiber reinforced insulation preform into the second shape.

In some embodiments, an exemplary method for making a fiber reinforced insulation product may include providing a fiber reinforced insulation preform and positioning the fiber reinforced insulation preform into an inner mold. The method may further include positioning the inner mold into an outer mold. The method may also include applying pressure to the outer mold such that the outer mold imparts pressure onto the inner mold to compress the fiber reinforced insulation preform positioned within the inner mold. The method may also include removing the inner mold from the outer mold. The method may further include drying the fiber reinforced insulation preform positioned within the inner mold and curing a binder of the fiber reinforced insulation preform. The inner mold includes a plurality of apertures that may be configured to allow moisture from the fiber reinforced insulation preform to pass through the inner mold while substantially preventing fibers from the fiber reinforced insulation preform from passing through the inner mold such that the fiber reinforced insulation preform dries and cures to form the fiber reinforced insulation product.

### BRIEF DESCRIPTION OF THE DRAWINGS

The present invention is described in conjunction with the appended figures:

FIGS. 1A and 1B schematically illustrate perspective views of a pipe with insulation product positioned about the pipe.

FIG. 1C illustrates a cross sectional view taken along line C-C of FIG. 1B.

FIG. 1D schematically illustrates a perspective view of another pipe with insulation product positioned about the pipe.

FIG. 1E schematically illustrates a perspective view of one section of insulation product.

FIG. 2 schematically illustrates an exemplary system for forming an insulation product.

FIGS. 3A-3C schematically illustrate an exemplary mold assembly for forming an insulation product.

FIGS. 4A-4F illustrate various exemplary inner molds for forming an insulation product.

FIGS. 5A and 5B schematically illustrate another exemplary system for forming an insulation product.

FIG. 6 illustrates an exemplary method of forming an insulation product.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

“ASTM” refers to American Society for Testing and Materials and is used to identify a test method by number. The year of the test method is either identified by suffix following the test number or is the most recent test method prior to the priority date of this document.

Described below are various insulation products and various molds and systems for forming the insulation products. In some embodiments, a two-piece or nested mold design where a perforated inner mold for drying/curing and a matching outer mold for pressing and molding may be implemented. Only the inner perforated mold is put into the drying and curing oven. The inner perforated mold can be configured or adapted to be used with existing molds for quick production of the insulation products. The two-piece or nested mold design reduces insulation production costs as well as mold manufacturing cost.

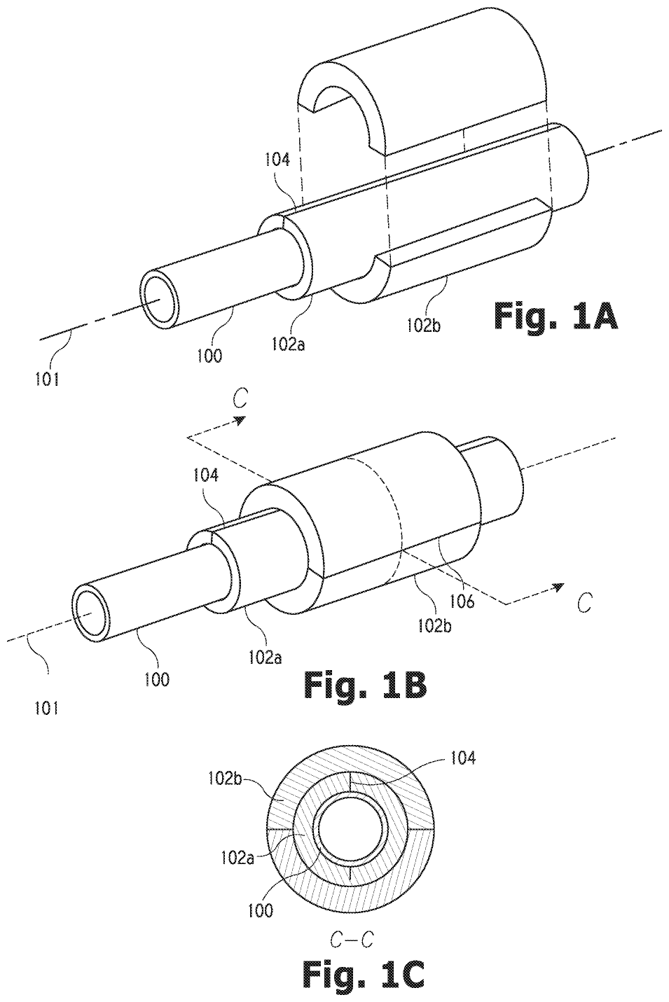

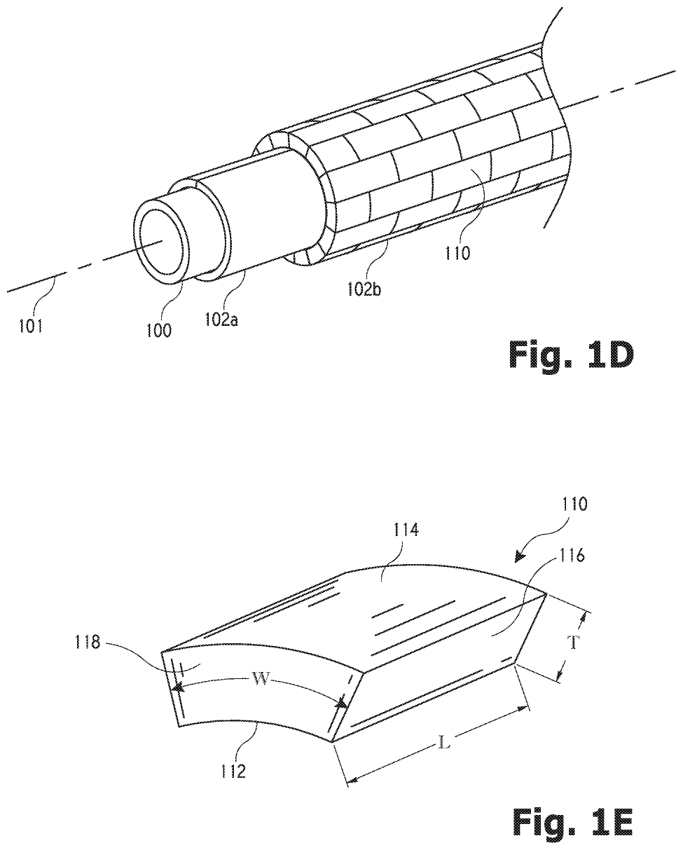

FIGS. 1A and 1B illustrate perspective views of a portion of a pipe 100 with one or more layers 102 of an insulation product positioned about the pipe 100. In FIG. 1A, a section of the insulation product is shown in a partially disassembled state, and in FIG. 1B, the layers 102 are assembled around the pipe section 100. FIG. 1C illustrates a cross sectional view taken along line C-C of FIG. 1B. Although two insulation layers 102, i.e., an inner layer 102a of the insulation product and an outer layer 102b of the insulation product, are shown, depending on the particular application, the size and/or construction of the pipe 100 and/or each layer 102 of the insulation product, more or fewer layers 102 of the insulation product may be utilized.

The pipe 100 may be a cylindrical pipe or tubing having a longitudinal axis 101. The pipe 100 may be made of suitable materials for transporting fluids at relatively low temperatures. For example, the pipe 100 may transport fuel and/or chemicals, such as liquefied natural gas, ethylene, ammonia, nitrogen, hydrogen, or other fluids in their respective liquid states, and thus at various temperatures within or below the refrigeration temperature range or the cryogenic temperature range, such as below about 100° F., below about 0° F., below about −100° F., below about −200° F., below about −300° F., below about −400° F., or lower. For example, the insulated pipe 100 may transport liquefied natural gas at about −260° F., liquefied ethylene at about −155° F., liquefied ammonia at about −28° F., etc. Although a straight section of the pipe 100 is shown, the entire pipe system for transporting the fluids may include fittings for connecting straight pipe sections and/or other components for regulating the flow of the fluids. As will be described in more detail below, the insulation product may be preformed into any suitable shapes and sizes, such as by molding and/or various other manufacturing methods, such that layers or other shapes or forms of the insulation product may be installed onto pipe sections, fittings, and/or other components of the pipe system with minimal fabrication at the installation site.

The layers 102 of the insulation product may each be formed as a cylindrical body. Depending on the size and/or shape of the pipe 100, each layer 102 may be formed as a unitary or integral piece of the insulation product or may be formed by joining multiple pieces or sections of the insulation product. When fewer number of pieces are involved in forming an insulation layer 102 surrounding the pipe 100 or an adjacent inner layer 102, the installation time may be reduced. However, as the size of the pipe 100 increases, the layers 102 of the insulation product may be formed by joining multiple smaller pieces together, such as shown in FIG. 1D. The smaller pieces can be more efficiently stored and transported.

With reference to FIG. 1A, the inner layer 102a may be formed as a single or one-piece body, such a clamshell of two cylindrical halves joined by a hinge area. When installed onto the pipe 100, the clamshell closes about the pipe 100. The abutting longitudinal edges of the two cylindrical halves may define a longitudinal seam or joint 104 substantially parallel to the longitudinal axis 101 of the pipe 100. The longitudinal joint 104 may be sealed by sealants, adhesives, tapes, or any suitable sealing mechanism. The outer layer 102b may be formed by joining two separate cylindrical halves. FIG. 1A shows one of the cylindrical halves as positioned away from the nested inner layer 102a. When fitted around the pipe 100, or more specifically, around the inner layer 102a as shown in FIG. 1B, the abutting longitudinal edges of the two cylindrical halves of the outer layer 102b may form two longitudinal seams or joints 106 substantially parallel to the longitudinal axis 101 of the pipe 100, which may be sealed by sealants, adhesives, tapes, or any suitable sealing mechanism. In some embodiments, the inner layer 102a may be formed by joining longitudinal edges of two separate cylindrical halves, instead of a one-piece clamshell structure. In some embodiments, the outer layer 102b may be formed as a one-piece clamshell structure.

As can be seen from FIG. 1A, the longitudinal joints 106 of the outer layer 102b and the longitudinal joints 104 of the inner layer 102a may be rotationally offset from each other with respect to the longitudinal axis 101 of the pipe 100, and thus not overlap. In the embodiment of FIG. 1A, the longitudinal joints 106 of the outer layer 102b may be rotationally offset from the longitudinal joint 104 of the inner layer 102a by about 90 degrees. The longitudinal joints of adjacent layers 102 may be offset by other appropriate angles in various embodiments. For example, the offset angle may be at least about ⅕, at least about ¼, at least about ⅓, or at least about ½ of the angle defined by the circumferential extension of the insulation product pieces forming each layer 102, such as the cylindrical halves or sections of FIG. 1A or the curved sections of FIG. 1D forming the outer layer 102b as described below.

FIG. 1A illustrates only one clamshell body of the inner layer 102a covering a portion of the longitudinal extension of the pipe 100, but the inner layer 102a may include multiple clamshell bodies axially placed along the longitudinal extension of the pipe 100 in an abutting manner. The abutting ends or edges of the clamshell bodies may form circumferential seams or joints which may be sealed by sealants, adhesives, tapes, or any suitable sealing mechanism. Similarly, the outer layer 102b may include additional cylindrical halves axially placed along the longitudinal extension of the inner layer 102a in an abutting manner. The abutting ends or edges of the cylindrical halves may form circumferential seams or joints which may be sealed by sealants, adhesives, tapes, or any suitable sealing mechanism.

As can be seen from FIG. 1A, the circumferential joints formed by the pieces of the outer layer 102b may be offset from the circumferential joints formed by the pieces of the inner layer 102a. In some embodiments, the upper cylindrical halves of the outer layer 102b shown in FIG. 1A may be further axially offset from the lower cylindrical halves. Consequently, the circumferential joints formed by the abutting edges of the upper cylindrical halves may be also axially offset from the circumferential joints formed by the lower cylindrical halves. In some embodiments, adjacent pairs of upper and lower cylindrical halves of the outer layer 102b may be rationally offset from each other such that the longitudinal joints of adjacent pairs of upper and lower cylindrical halves may be rationally offset from each other. Similarly, the adjacent clamshells of the insulation layer 102 may be placed such that the longitudinal joints of the adjacent clamshells may be rationally offset from each other. The term circumferential or circumference used herein may refer to the entire circular periphery of the pipe 100 or the insulation layer 102, or may refer to only a portion of the circular periphery of the pipe 100 or the insulation layers 102, such as an arc or a segment of the circular periphery as defined by the insulation pieces forming the insulation layers 102. Further, the pipe 100 and/or the insulation layer 102 may be cylindrical as shown in FIG. 1A, but may be formed of any other suitable shapes, such as an oval or polygonal shape. Accordingly, the term circumferential or circumference used herein may refer to the periphery, or portions thereof, of any shape the pipe 100 or insulation layer 102 may be formed of, which may include straight or curved peripheral portions.

As the size of the pipe 100 and/or the insulation layer 102 increases, the insulation layer 102 may be formed by joining multiple relatively small segments or sections of the insulation product as shown in FIG. 1 D. Although only two insulation layers 102, i.e., the inner layer 102a and the outer layer 102b are shown, more or less layers 102 may be implemented. FIG. 1 E illustrates one section 110 of the insulation product. The insulation product section 110 includes an inner surface 112, an outer surface 114, two opposing longitudinal sides or ends 116, and two opposing circumferential sides or ends 118. The distance between the inner surface 112 and the outer surface 114 defines a thickness T of the insulation product section 110. The distance between the two longitudinal sides 116 defines a width W of the insulation product section 110. The distance between the two circumferential sides 118 defines a length L of the insulation product section 110.

The inner surface 112 and the outer surface 114 may be parallel to each other, and thus define a uniform thickness T of the insulation product section 110. The thickness T may range between about 0.5 inches and about 2 inches, between 0.75 inches and about 1.5 inches, or between about 1 inch and about 1.25 inches in various embodiments. The insulation product section 110 may also be made with a thickness T greater than 2 inches or less than 0.5 inches. The two circumferential sides 118 of the insulation production section 110 may be parallel to each other, and thus define a uniform length L of the insulation product section 110. The insulation product section 110 may have a typical length L of about 36 inches, but other length dimensions may be adopted.

Depending on the shape of the pipe section or components surrounded by the insulation product section 110, the inner surface 112 and the outer surface 114 may include two curved surfaces each respectively forming a portion of one of two co-axially aligned cylindrical surfaces about the longitudinal axis 101 of the pipe 100. The insulation product section 110 may include a varying width W. For ease of discussion, the width W of the insulation product section 110 may be defined as the arc length measured at the mid-point of the thickness T of the insulation product section 110. The ratio of the length L to the width W of the insulation product section 110 may be at least or about 1:1, at least or about 1.5:1, at least or about 2:1, at least or about 3:1, or greater, and the ratio of the width W to the thickness T of the insulation product section 110 may be at least or about 1:1, at least or about 2:1, at least or about 3:1, at least or about 4:1, at least or about 5:1, at least or about 6:1, or greater to effectively utilize storage space during transportation, while maintaining sufficient structural integrity of the insulation product sections 110 for ease of handling during installation. In some applications, such as insulation for pipe sections with relatively small diameters, the insulation product section 110 may include a much greater length L, e.g., about 36 inches, than its width W, e.g., about 3 inches, and the ratio of the length L to the width W of the insulation product section 110 may be at least or about 4:1, at least or about 6:1, at least or about 8:1, at least or about 10:1, at least or about 12:1, at least or about 15:1, or greater. In some applications, such as insulation for pipe sections with relative large diameters or insulation for relatively flat surfaces, the insulation product section 110 may be produced in relatively large, but relatively thin pieces, such as sections that are about 18 inches wide and about 1 inch thick, and the ratio of the width W to the thickness T of the insulation product section 110 may be at least or about 10:1, at least or about 12:1, at least or about 14:1, at least or about 16:1, at least or about 18:1, at least or about 20:1, or greater.

Similar to the embodiment shown in FIG. 1A, when joined together to form the insulation layers 102, each insulation product section 110 may be axially or rotationally offset from an adjacent insulation product section 110. Consequently, the longitudinal joints formed by adjacent insulation product sections 110 of one insulation layer 102 may be rotationally offset from the longitudinal joints formed by adjacent insulation product sections 110 of adjacent inner and/or outer insulation layers 102, and the circumferential joints formed by adjacent insulation product sections 110 of one insulation layer 102 may also be axially offset from the circumferential joints formed by adjacent insulation product sections 110 of adjacent inner and/or outer insulation layers. The longitudinal and/or circumferential joints formed by the insulation product sections 110 within each insulation layer 102 may be further offset from each other. The offset arrangement of the seams or joints minimizes or substantially prevents vapor condensation travelling cross the layers 102. The offset arrangement also improves thermal performance by reducing thermal bridging at the joint lines.

As will be discussed in more detail below, the insulation product pieces forming the insulation layers 102, such as the clamshells, the cylindrical halves, or the cylindrical sections described herein, may be pre-fabricated with inner and/or outer facers. The inner facer may include a woven or nonwoven layer, and the outer facer may include a vapor barrier facer. The facers may improve the structural integrity of the insulation pieces and may minimize dust that may be generated during transportation and installation. The insulation pieces may further include joining or sealing tapes along the edges of the insulation pieces or other pre-applied adhesives that may be quickly activated in the field. The pre-fabricated facers and sealing mechanisms allow for quick installation and reduce overall cost of the insulation system.

In the entire piping system, for every predetermined length of a straight pipe section, vapor barrier stops may be applied to prevent any moisture trapped between the pipe 100 and the insulation layers 102 from travelling axially for an extended distance. FIG. 1D illustrates an end portion of one such predetermined length of the straight pipe section. At the end portion, the circumferential end of the inner layer 102a and the circumferential end of the outer layer 102b may be axially offset from each other with the circumferential end of the inner layer 102a extending beyond the circumferential end of the outer layer 102b. A vapor barrier stop may be applied along the stepped profile defined by the pipe 100, the inner layer 102a, and the outer layer 102b. A more thorough or complete description of the vapor barrier stop is provided in U.S. patent application Ser. No. 16/128,692, the entire disclosure of which is hereby incorporated by reference.

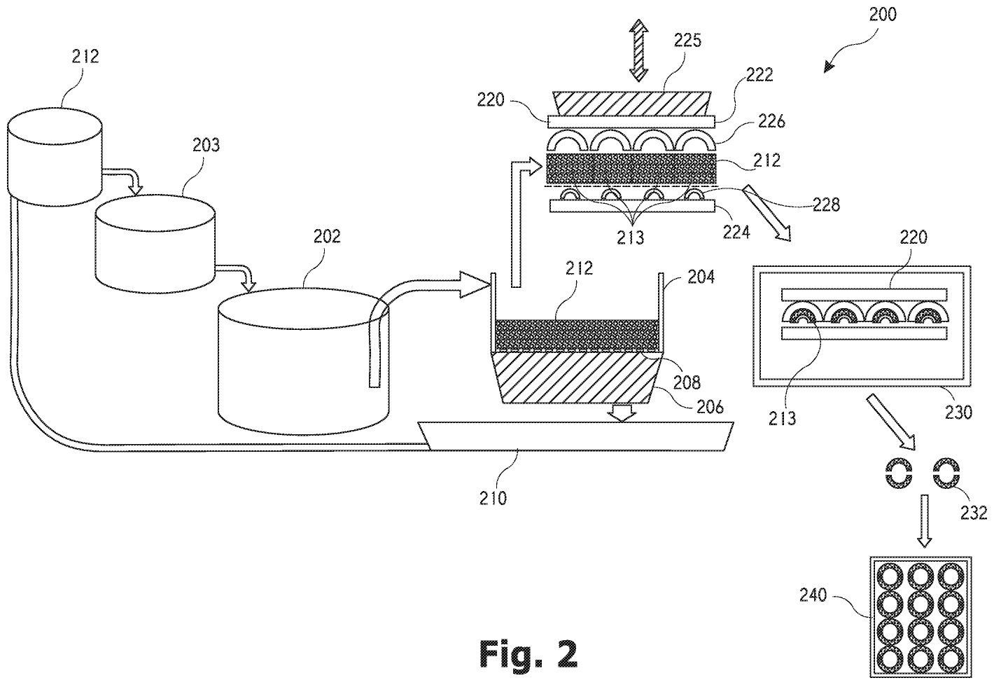

FIG. 2 schematically illustrates a system 200 for forming an insulation product that may be used to form insulation layers for pipes as discussed above with reference to FIGS. 1A-1E. The system 200 includes a mixing chamber 202, such as a hydro pulper for mixing aerogel particles, reinforcing fibers, a binder, and various additives, including a water repellent additive, in an aqueous solution (also referred to as whitewater) to form a slurry. Various mixing or blending techniques, including paddle wheel mixing, may be utilized. Vortex mixing may also be utilized to blend the ingredients together without being mechanically abusive to the ingredients, such as breaking the fibers into shorter lengths or grinding the aerogel into finer particles. In some embodiments, recycled insulation product particles may also be added to the whitewater solution for forming the mixture as will be discussed below. To maintain the uniform or homogenous distribution of the various ingredients in the mixture, the mixture may be used soon after the desired uniformity is achieved, such as within minutes, so that the mixture does not begin to separate or settle and become non-uniform.

The whitewater may include surfactants and viscosity modifiers, similar to the whitewater used to manufacture nonwoven glass mats such as described in U.S. Pat. No. 10,003,056, the entire disclosure of which is hereby incorporated by reference. The whitewater may facilitate the even distribution of the ingredients in the slurry. The whitewater may be fed into the mixing chamber 202 from a whitewater container 203, which may be used to prepare the whitewater solution using in part recycled whitewater as will be described in more detail below.

The aerogel particles are synthetic highly porous and ultralight weight materials. The aerogel particles are typically made through a sol-gel process, although any other process of forming the aerogel particles known in the art may be employed. The aerogel particles are excellent thermal insulators due to being extremely light weight, low density (i.e., 98% air), and having extremely small pore sizes, which typically are between 10 nm and 40 nm. The nano-sized pores of the aerogel particles enable the aerogel particles to exhibit low thermal conductivity by essentially eliminating convection and gas conduction heat or thermal energy transfer. In some embodiments, the aerogel particles used for making the insulation product may include hydrophobic silica aerogel particles. In some embodiments, the aerogel particles may also include various other materials, such as organic aerogels, polyimide aerogel, polyurethane aerogel, and the like. A more thorough or complete description of the aerogel particles is provided in U.S. patent application Ser. No. 15/804,834, the entire disclosure of which is hereby incorporated by reference.

Depending on the applications, the formed insulation product may include between about 50 wt % and about 75 wt % of the aerogel particles in the finished molded product. The aerogel particles may have a particle size or diameter between about 10 and 4,000 microns. In some embodiments, the aerogel particles used for forming the insulation product may have a particle size or diameter between 25 and 500 microns, or between 50 and 300 microns, or between 100 and 200 microns. Various other particle sizes for the aerogel particles may likewise be employed. A particle size of between 100 and 200 microns may enable the aerogel particles to be easily dispersed within a whitewater solution and allow the water to be easily drained during the formation of the insulation product. The aerogel particles may be hydrophobic, which enables the aerogel particles to be directly added to water in the insulation product formation process without the water, or other materials in the water, plugging the pores of the aerogel particles. If the pores of the aerogel particles are plugged, the desired insulative properties may be negated or eliminated.

The reinforcing fibers may include organic or inorganic fibers. The inorganic fibers improve fire resistance property of the insulation product. In some embodiments, the inorganic fibers may include glass fibers. The glass fibers may include a mixture of coarse glass fibers and glass microfibers. The coarse glass fibers may have an average fiber diameter between about 8 microns and about 20 microns. The average fiber length of the coarse glass fibers may range between about ¼ inches and about 1 to about 1% inches. In some embodiments, wet chop E glass fibers having an average fiber diameter of about 13 microns at about % inch length may be used for the insulation product. The glass microfibers may have an average fiber diameter between about 0.5 microns and about 3 microns. The length of the glass microfibers may range between about ⅛ inches and about 6 inches, more typically between about ⅛ inches and about 4 inches. In some embodiments, dry glass microfibers having an average fiber diameter of about 0.8 microns at about 20 microns length may be used for the insulation product.

The mixture of the coarse glass fibers and glass microfibers used for forming the insulation product may have a ratio of the coarse glass fiber diameter to the glass microfiber diameter between 40:1 and between 5:1, such as about 30:1, about 20:1, about 16.25:1, about 15:1, or about 10:1 in various embodiments. Depending on the applications, the insulation product may include between about 1 wt. % and about 6 wt. % of the coarse glass fibers, such as 3 wt. % of the coarse glass fibers, and include between about 5 wt. % and about 15 wt. % of the glass microfibers, such as 10 wt. % of the glass microfibers. The ratio of the weight of the coarse glass fibers in the formed insulation product to the weight of the glass microfibers may range between about 2:3 and about 1:3, such as about 3:10. Small additions of coarse fiber can significantly improve tensile and tear resistant in mats made predominately with glass microfibers. Glass microfibers can form interconnected webs or network that can hold or trap small particles, such as aerogel particles, in place. Although coarse glass fibers and glass microfibers are described as exemplary components of the glass fibers, the glass fibers may include only coarse glass fibers but not glass microfibers, or vice versa.

The binder may include a polysiloxane binder. To provide desired fire resistance for the finished product, fire resistant binders are used, such as high temperature binders or binders with low organic content, including polysiloxane. Other binders that are less fire resistant that may be used include polyacrylic, phenolic, polyethylene acrylate copolymer, polyethylene vinyl acetate and polyvinyl alcohol. In some embodiments, the binder may further include a flocculating agent, such as ferric nitride. The flocculating agent aggregates the binder and other liquid additives, or stated differently, agglomerates the micelles of binder and water repellent in the whitewater, so that they can accumulate on solid surfaces of the fibers and aerogel particles. This way, the binder and/or other liquid additives remain on the solid surfaces instead of passing or flowing through the mixture and into the whitewater recycle tank. As shown below, the flocculating agent used can also improve strength of the insulation product. One exemplary flocculating agent may include ferric nitride because it is inorganic, which helps maintain product fire resistant, and it improves product strength compared to Alum. Further, ferric nitride converts to iron oxide, which acts as an opacifier to block radiative heat transfer at temperatures above room temperature.

The water repellent additive may include a silicone emulsion to improve water resistance of the insulation product. In some embodiments, the silicon emulsion may include emulsions made with reactive silicon, such as SF75 manufactured by Dow Corning. The reaction of the silicone emulsion may be activated and/or facilitated by drying and elevated temperature curing to provide the desired water repellency for the insulation product. In some embodiments, a fluoropolymer water repellent additive may be used.

With continued reference to FIG. 2, once the aerogel particles, glass fibers, binder, and the various additives are mixed and form a substantially homogenous mixture, the mixture is then transferred into a dewatering box 204. The mixture may be dewatered by vacuum generated by a vacuum table 206 underneath the dewatering box 204. In some embodiments, the mixture may be dewatered through compression or by gravity. In some embodiments, the bottom of the dewatering box 204 may be lined with a carrier layer 208, which may be then subsequently bonded to the mixture and form an inner facer of the finished insulation product. The carrier layer 208 may be omitted in some embodiments. The carrier layer 208 may include a woven or nonwoven material, such as polyester, glass nonwoven, spunbond, scrim, or other suitable carrier materials. The carrier layer 208 is porous such that excess water may be removed in the subsequent dewatering and/or subsequent drying process.

Through the dewatering process, a substantial amount of the whitewater solution may be removed. Because the insulation product may be designed for cryogenic applications, and in the cryogenic temperature range, such as below 75° F., black opacifiers, such as carbon black, offer limited benefits in the thermal properties of insulation products, the insulation product may be made without carbon black or other black opacifiers. By eliminating carbon black or other black opacifiers, a closed loop whitewater system may be formed and the insulation product may be manufactured more efficiently. Specifically, the liquid removed from the mixture through the dewatering process may be drained into a whitewater recycle trough 210 and collected and processed in a whitewater recycler 212. The recycled whitewater may then be reused. Depending on the particular dewatering process employed, a minimum of 50 wt. % and as much as 90 wt. % of the liquid or process water may be readjusted to the desired viscosity and surfactant concentration to add back into the whitewater tank and reused.

After the dewatering process, a blanket 212 of entangled fibers with the aerogel particles embedded therein, the binder, and other additives uniformly distributed throughout the blanket 212 may be formed in the dewatering box 204. About 50 wt. % to about 66 wt. % of water may still remain in the blanket 212. Because the aerogel particicles are hydrophobic, the residual whitewater and the wet binder contains the remaining water content in the blanket 212. The remaining water content may be removed during subsequent drying and/or curing process as discussed below.

Depending on the final form of the insulation product, the amount of the slurry mixture pumped into the dewatering box 204 may be controlled such that after dewatering, the blanket 212 formed may have a thickness ranging between about 1 inch to about 4 inches, and in some embodiments about 2 inches. The thickness of the blanket 212 may be reduced during subsequent molding process for forming the insulation product. The density of the blanket 212 formed after the dewatering process may range between about 7 pcf to 20 pcf, which may be increased during the subsequent molding process. For example, during the molding process, a 1.5″ thick dewatered blanket having a density of about 10 pcf may be compressed to about 1″ thickness. If no further water or whitewater is squeezed out of the dewatered blanket during the molding process, the density of the dewatered blanket may be increased to 15 pcf before drying and curing.

With continued reference to FIG. 2, once dewatered, the blanket 212 of entangled fibers may be transferred to a mold assembly 220. In some embodiments, before transferring to the mold assembly 220, the blanket 212 may be further cut into multiple sections 213 each of which would be molded into an insulation product piece. The blanket 212 or the cut sections 213 may also be referred to as preforms. The mold assembly 220 may include an upper mold member 222 and a lower mold member 224. The upper mold member 222 may be moved by a mold press 225 upward or downward relative to the lower mold member 224 to open and close the mold assembly 220. The upper mold member 222 may include one or more upper mold halves 226, each of which may take the form of a cylindrical half. The lower mold member 224 may include a corresponding number of lower mold halves 228, each of which may also take the form of a cylindrical half. When the mold assembly 220 is closed, each of the upper mold half 226 is configured to operate with a corresponding lower mold half 228 to further compress and mold the blanket 212 or sections 213 into the proper form of the insulation product, such as cylindrical halves as illustrated in FIG. 2.

Although molds of a cylindrical shape are described herein as an example, the molds may be formed by cooperating pieces that may define an arc greater than or less than a half circle. In some embodiments, instead of curved molding surfaces, the molding surfaces may be flat. FIG. 2 illustrates that the upper mold halves 226 and the lower mold halves 228 are configured in a downward facing manner with the upper mold halves 226 having a greater inner diameter than the outer diameter of the lower mold halves 228. In some embodiments, the upper mold halves 226 and the lower mold halves 228 may be configured in a generally upward facing manner with the lower mold halves 228 having a greater inner diameter than the outer diameter of the upper mold halves 226. The upper and lower mold haves 226, 228 may include water drainage or vapor outlets.

As discussed above, the preforms, or the blanket 212 or blanket sections 213, may be obtained by using vacuum, compression, and/or gravity to remove excess water from the slurry mixture. Accordingly, the dewatering process may effectively pack the slurry mixture into a denser damp mixture, which provides structural integrity to the preforms. The flocculating agent and/or the spunbond or other nonwoven carrier layer 208, including nonwoven glass fiber mat, may also add structural strength to the preforms. With sufficient structural integrity, the preforms may be molded into the various final forms of the insulation product without using a fully closed mold. For example, the mold assembly 220 is configured such that the side(s) or end(s) of each pair of mold halves may be left open, which may significantly reduce drying/curing time. Depending on the thickness of the insulation products, the molded blanket sections 213 and the mold assembly 220 may be dried and cured in a drying oven 230 at about 350° F. to about 500° F. for as little as about 30 minutes to 3 hours to substantially remove all the remaining water content.

Because after dewatering, the preform may still contain about 50 wt. % or more of water content, the processing in the oven 230 may begin with a drying process. When the water evaporates and the binder is exposed to temperatures above about 100° C., the binder starts to cure to bond the entangled fibers and the embedded aerogel particles together. The binder also bonds the carrier layer 208 to the inner or concave surface of the blanket sections 213. In some embodiments, a steam pressure autoclave may be used to cure the binder while water is still in the preform.

During the drying and/or curing process, the water repellent additive dries and cures at the same time the binder dries and cures. The water repellent additive provides water repellency throughout the insulation product. However, because of the drying process occurs outside to inside, some water repellents may slightly wick into the drier portion of the insulation product, which may make the surface portion more water repellent that the inner insulation core.

When cured, the molded blanket sections 213 forms a molded aerogel insulation product, which is a fiber reinforced aerogel composite or glass fiber reinforced aerogel composite in some examples. The molded aerogel insulation product is then demolded and trimmed, and insulation product sections 232 are produced. In some embodiments, the insulation product sections 232 may each be fabricated with an outer facer or a vapor barrier facer. The vapor barrier facer may be applied after the insulation product sections 232 are molded. Alternatively, the vapor barrier facer may be laid on the dewatered blanket 212 before it is compressed and molded. The vapor barrier facer may be bonded to the outer or convex surface of the insulation product sections 232 by the binder. The vapor barrier facer may include aluminum foil at a thickness of about 0.001″ to about 0.005″. The inner spunbond or other nonwoven facer and the outer vapor barrier facers may improve the structural integrity of the insulation pieces and/or minimize dust that may be generated during packaging 240, transportation, and/or installation.

As discussed above, drying and/or curing the preforms may take about 3 hours or longer in some embodiments. The long period of drying/curing time is partly due to the high water content included in the preforms held in the constrained space of the individual molds while the preforms dry/cure. The long period of drying/curing time is also due to the time needed to heat up the molds that press and shape the individual preforms. Once the preforms dry and cure, the molds may be cooled, which can also take significant amount of time. The dried/cured insulation may then be demolded, and the molds may be cleaned. During the molding, drying, curing, cooling, demolding and/or cleaning process, each mold may be tied up for up to, e.g., about 5 hours. In some embodiments, a mold assembly, such as the mold assembly 200 discussed above, may include multiple molds for processing multiple preforms in one batch in order to improve production efficiency. Nonetheless, to produce significant quantities of insulation products in a single size, many molds may be needed. Further, to produce various sizes/shapes of the finished products that the market demands, the number of molds needed further increase. The time involved for dying/curing the preforms and the expenses associated with the various molds can lead to high manufacturing cost.

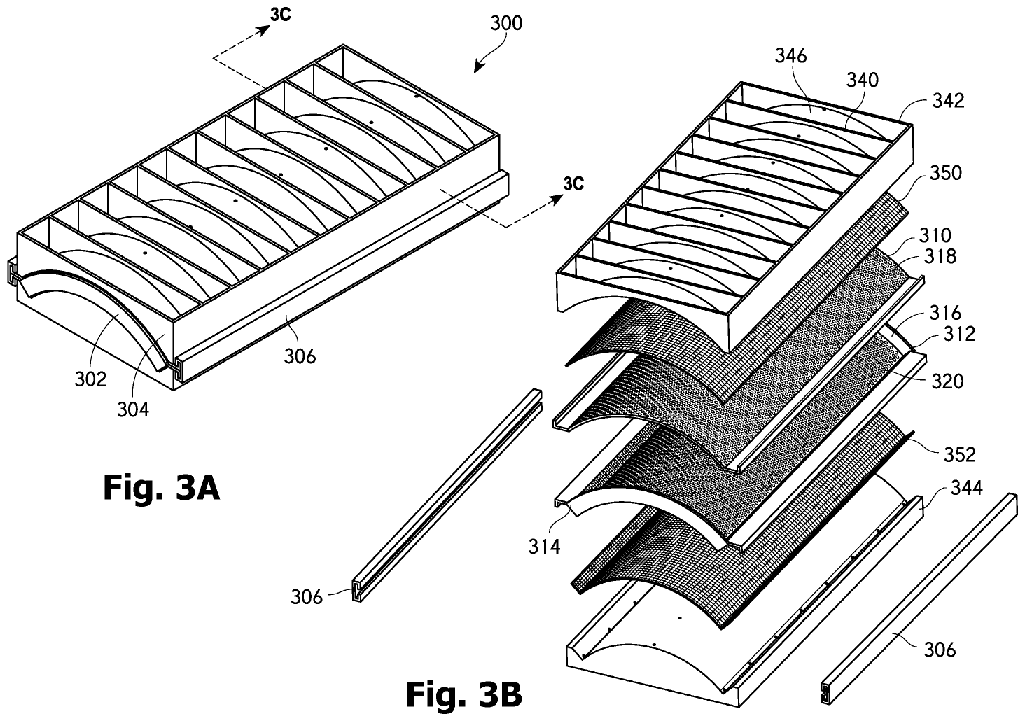

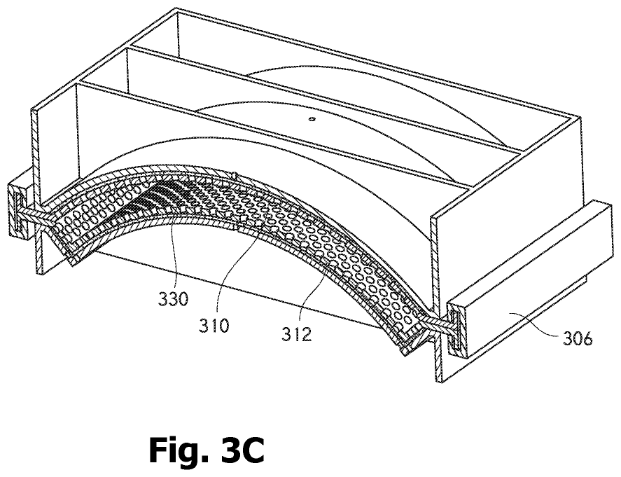

FIG. 3A-3C schematically illustrates an exemplary mold assembly 300 that may reduce drying/curing time, and thus reduce costs associated with insulation production. The mold assembly 300 may also reduce expenses associated with mold manufacturing. FIG. 3A schematically illustrates the mold assembly 300 in an assembled configuration. FIG. 3B schematically illustrates an exploded view of the mold assembly 300. FIG. 3C schematically illustrates a cross sectional view of the mold assembly 300 taken long line 3C-3C of FIG. 3A. The mold assembly 300 may be used for forming an insulation product that may be used to form insulation layers for pipes as discussed above with reference to FIGS. 1A-1E.

With reference to FIG. 3A, the mold assembly 300 includes an inner mold 302 and a matching outer mold 304. The inner mold 302 and the outer mold 304 match in that the inner mold 302 is configured to be removably received inside the mold cavity of the outer mold 304, and the inner mold 302 substantially fills the mold cavity of the outer mold 304 and conforms to or match up with the interior of the outer mold 304. During operation, a preform of a moldable material may be received inside the cavity defined by the inner mold 302. The inner mold 302 containing the preform may be placed inside the mold cavity of the outer mold 304. The outer mold 304 may be configured to provide dimensional stiffness and/or rigidity such that when the outer mold 304 closes, the outer mold 304 presses against the inner mold 302, thereby pressing the preform to a desired shape and/or dimension. The mold halves of the inner mold 302 may include guides and/or flanges, shown in FIG. 3C, that extend outside the outer mold 304. Once the preform has been pressed into a desired shape and/or dimension, side clamp strips or clips 306 or other suitable clamping or fastening mechanism, such as C-clamps, may slide onto the guides and/or flanges and hold the mold halves of the inner mold 302 together. The inner mold 302 containing the pressed preform may then be removed from the outer mold 304, and moved to an oven for drying/curing. Because only the inner mold 302 is placed in the oven, the drying/curing time can be reduced in comparison with conventional molds.

Although a preform is described herein as an example, layers of preforms or other moldable materials, or loose moldable material may be packed or placed using any suitable techniques inside the mold cavity of the inner mold 302 for drying/curing. A more thorough or complete description of exemplary moldable materials or preforms, as well as exemplary insulation products formed, is provided in U.S. patent application Ser. Nos. 16/128,886, 16/129,005, and 16/129,259, the entire disclosures of which are hereby incorporated by reference. Examples of other moldable materials that may benefit from the present technology may include ZIRCAR Alumina-Silica Insulating Blanket Type RS-C Moldable, Microtherm Group MT Thermosphere® Moldable Insulation Paste, Johns Manville Moldable Glass Wool blanket, damp Johns Manville Spider® Plus, damp Guardian Ultrafit DS as described in U.S. patent application Ser. No. 5,952,418, or moldable cellulose materials that are formed into products, such as Homasote 440 SoundBarrier® and Johns Manville Fesco® Board.

With reference to FIGS. 3B and 3C, the inner mold 302 may include an upper mold 310 and a lower mold 312 that each define an arc and that collectively define an arched or curved mold cavity 330. The upper mold 310 and/or the lower mold 312 may be formed using perforated plate or sheet materials, or other relatively thin materials. Therefore, the inner mold 302 may have a relatively low ratio of mold weight to mold cavity volume. The weight of the inner mold 302 depends on the size of the mold, types of the material and thickness of the material used for making the mold, perforation size, open area, and the like, but the ratio of mold weight to mold cavity volume is generally lower as compared to conventional molds. In some embodiments, the inner mold 302 may be fabricated from steel and may weigh between about 10 lbs and about 100 lbs or between about 20 lbs and about 50 lbs. For example, an inner mold made of steel for producing 6″ diameter insulation may have a combined weight of about 25 lbs. An inner mold for producing 20″ diameter quad sections may weight about 43 lbs when made using 0.12″ steel, and may weight about 87 lbs when made using 0.25″ steel. A ratio of the weight of the inner mold 302 to the volume of the mold cavity 330 may range between about 40 pcf and about 400 pcf, between about 80 pcf and about 280 pcf, or between about 100 pcf and about 140 pcf. For example, an inner mold that is made of 0.12″ thick steel perforated with ⅛″ holes for producing 6″ diameter insulation may have a ratio of weight to cavity volume of about 95 pcf, and an inner mold for producing 20″ diameter quad sections of insulation may have a ratio of weight to cavity volume of about 119 pcf. The weight-to-volume ratio may be further reduced when a lighter material may be used. For example, the weight-to-volume ratio may be reduced by 50% or more when aluminum or other lighter material is used for mold fabrication. When stainless or other dense material is used instead of steel, the weight-to-volume ratio may increase by, e.g., about 28%.

The light-weight construction of the inner mold 302 allows the pressed preform to be heated significantly faster than conventional molds, which typically have a significant material mass that must be heated in order to dry and cure the molded materials. The inner mold 302 described herein significantly reduces the heating and cooling time of the mold, which greatly reduces the time required to dry and cure the preform or other molded materials. The perforation in the inner mold 302 allows the water content from the preform to evaporate easily, which further reduces the drying/curing time. The material for forming the inner mold 302 and/or the perforation configuration therein may be selected based on several factors, including but not limited, a required stiffness of the inner mold 302 to maintain the pressed shape and/or dimension of the preform once the preform is removed from the outer mold 304, the drying/curing time, the size and/or shape of the insulation to be formed, the surface finishing of the dried/cured insulation, and the like.

The stiffness and/or rigidity of the inner mold 302 may be significantly less than that of the outer mold 304. This is because once the preform is shaped by the outer mold 304, the outward force that the pressed or shaped preform may exert on the inner mold 302 may be relatively small. Therefore, the material type and/or the thickness for forming the inner mold 302 may be selected to provide the inner mold 302 with a sufficient stiffness and/or structural strength such that once the preform has been pressed into desired the shape and/or dimension by the outer mold 304, the inner mold 302 can maintain the shape and/or dimension of the preform for drying/curing without requiring the outer mold 304 to be pressed against the inner mold 302. Depending on the particular material, the thickness of the plate or sheet material forming the inner mold 302 may range between about 0.075″ (14 GA) or less and about ¼″ (3 GA) or greater. In some embodiments, when steel is used for forming the inner mold 302, the thickness of the steel plate or sheet may be less than or about ⅜″, less than or about ¼″, less than or about ⅛″, less than or about 0.075″, or less. For example, when carbon steel is used for fabricating molds for making curved pipe insulation sections of about 20″ by 36″, a perforated, HRPO (hot rolled pickled and oiled) carbon steel sheet that is 0.1196″ thick (11 Gauge) may be used. The perforation may include ⅛″ holes in a staggered arrangement having a 3/16″ center-to-center distance, and may define about 40% open area. Other materials with appropriate thickness may be utilized, such as stainless, aluminum, copper, and the like. In some embodiments, a liner material, such as a porous layer, may be provided to cover the inner surface of the inner mold 302. The liner material is often chosen based on perforated metal sheet used, the liner material's durability to undergo multiple molding cycles and the strength necessary to hold the molded material to the dimensions. One exemplary liner material may include a polytetrafluoroethylene (PTFE) fabric layer.

The mold halves 310, 312 may each include a substantially uniform thickness (excluding the perforations) as defined by the sheet material forming the inner mold 302. Consequently, the shape of the mold cavity defined by the outer mold 304 can be reproduced by the inner mold 302. Further, with appropriate thickness configuration, the volume of the mold cavity defined by the outer mold 304 can also be substantially reproduced by inner mold 302. In some embodiments, the volume of the mold cavity defined by the inner mold 302 may be greater than or about 90%, greater than or about 95%, greater than or about 97%, greater than or about 99% of the volume of the mold cavity defined by the outer mold 304. Consequently, an inner mold, similar to the inner mold 302 described herein, may be constructed for any existing molds so as to reduce drying/curing time. The light-weight construction of the inner mold 302 not only reduces the drying/curing time, but also reduces stress placed on the oven structure as compared to conventional molds even when multiple inner molds 302 are placed in the oven for drying/curing multiple preforms simultaneously.

In some embodiments, the various pieces forming the inner mold 302 may be constructed with similar or different structural strengths. Because the lower mold 312 may bear the majority of the preform's weight during drying/curing, the lower mold 312 may be constructed with a different material and/or thickness than that of the upper mold 310 so as to provide the lower mold 312 with greater stiffness and/or strength as compared to the upper mold 310. In some embodiments, the lower mold 312 may be reinforced with two non-perforated circumferential sides or longitudinal ends 314, 316. The circumferential sides 314, 316 may also limit longitudinal expansion of the preform as the preform is pressed into a desired shape and/or dimension by the outer mold 304. In some embodiments, the circumferential sides 314, 316 may also be perforated. Depending on the shape and/or size of the insulation to be produced, the lower mold 312 may not need additional reinforcement even though it bears the weight of the preform because the curvature or shape of the lower mold 312 may provide sufficient structural strength. Although FIG. 3B illustrates that the lower mold 312 may include reinforcing sides/ends, in some embodiments the upper mold 310 may also be reinforced in a similar manner such that a thinner or lighter plate or sheet material may be used and/or a greater perforated area may be implemented. Further, in some embodiments, neither the upper mold 310 nor the lower mold 312 may include a reinforcement. For example, for manufacturing relatively small molded insulation pieces, the mold halves 310, 312 may not require any additional reinforcement because the span of the mold halves 310, 312 may be less than those needed for manufacturing relatively large insulation pieces.

The drying/curing of the preform is further facilitated by the perforations formed in the inner mold 302 as the perforated inner mold 302 readily permits moisture, water, water vapor, or other fluids to escape from the mold and enables convective drying to occur. As schematically illustrated in FIG. 3B, the upper mold 310 includes a plurality of apertures or through holes 318 that are formed in the mold body. The lower mold 312 also includes a plurality of apertures or through holes 320 that are formed in the mold body. The apertures 318, 320 are shaped and/or sized so that moisture, water, water vapor, or other fluids are able to escape from the mold by passing through the apertures 318, 320, but so that components or materials that form the preform, such as fibers, aerogel particles, and the like, are not able to pass through the apertures 318, 320 as the preform is pressed by the outer mold 304 into a suitable shape and/or dimension. Accordingly, the components or materials that form the preform remain trapped and compressed by the upper and lower molds 310, 312 while other materials that are typically removed during drying are able to escape. In some embodiments, only one of the upper mold 310 or the lower mold 312 may be perforated.

The apertures 318, 320 may be circular, oval, triangular, square, rectangular, diamond, pentagonal, hexagonal, or of any suitable shape . The shape of the apertures 318, 320 may be symmetrical or asymmetrical. In some embodiments, the apertures 318, 320 may be elongated slots that may be oriented along the longitudinal extension of the inner mold 302, along the circumferential extension of the inner mold 302, or in any other suitable orientation, such as diagonal to the longitudinal extension of the inner mold 302.

In the embodiment shown in FIG. 3B, the apertures 318, 320 are circular. The diameter of the apertures 318, 320 may be less than or about 0.5″ and may range between about 1/16″ and about ¼″, and in some embodiments , the apertures 318, 320 may have a diameter of about ⅛″. The apertures 318, 320 may be arranged in an alternating or staggered manner and may be spaced apart from each other at an equal distance. For example, each aperture 318, 320 may be disposed at the center of a hexagon defined by six adjacent apertures 318, 320 disposed at the vertices or corners of the hexagon. Adjacent apertures 318, 320 may be spaced apart from each other by a distance that is about the radius of the apertures 318, 320. In other words, the distance between the centers of two adjacent apertures 318, 320 may be about three times the radius of the apertures 318, 320. For example, when the apertures 318, 320 have a diameter of about 1/16″, about ⅛″, or about ¼″, the center-to-center distance may be about 3/32″, about 3/16″, or about ⅜″, respectively. The apertures 318, 320 arrangement and/or the center-to-center distance may be adjusted or varied as desired or as required based on a given application. In the embodiment shown in FIG. 3B, the apertures 318, 320 are roughly equivalent in size and shape and are disposed among the entire surfaces of the upper mold 310 and the lower mold 312 so that a density of the apertures 318, 320 in any given area of the molds is substantially the same. In other embodiments, the upper mold 310 and/or the lower mold 312 may only include apertures 318, 320 in select areas, and/or may include apertures 318, 320 with varying sizes, shapes, and/or aperture densities.

The apertures 318 of the upper mold 310 may collectively define an open area of about 40% of the surface area of the upper mold 310 that contacts the preform. In some embodiments, the apertures 318 may collective define an open are of between about 20% and about 60%, between about 30% and about 50%, or about 40% of the surface area of the upper mold 310, the apertures 320 of the lower mold 312 may collectively define an open area of about 40% of the surface area of the lower mold 312 that contacts the preform. In some embodiments, the apertures 320 may collective define an open area of between about 20% and about 60%, between about 30% and about 50%, or about 40% of the surface area of the lower molding half 312. The open areas defined by the apertures 318, 320 in the upper mold 310 and the the lower mold 312 may be the same or different in various embodiments.

The size and/or shape of individual apertures 318, 320 and the collective size of the open area in the upper mold 310 and/or the lower mold 312 may be determined based on a variety of factors, including but not limited, the desired drying/curing speed, the structural strength of the inner mold 302, the structural integrity of the formed insulation product, and the like. In addition to facilitating moisture removal or evaporation, the apertures 318, 320 are also shaped and/or sized to limit or eliminate any preform materials , such as fibers and/or aerogel particles, from being pushed into and/or through the apertures 318, 320 when the preform is pressed into shape by the inner mold 302 and the outer mold 304. Limiting or eliminating the materials from being pushed into the apertures 318, 320 enables the formed insulation to have a substantially smooth surface finish, which may greatly improve the structural integrity and/or strength of the formed insulation.

Generally, the apertures 318, 320 are shaped and sized to limit the amount or degree to which the materials or components of the preform, or other moldable materials, are able to expand or protrude into the apertures 318, 320. For example, the apertures may be configured so that the preform materials or components expand or protrude less than about 50% through the apertures 318, 320, or stated differently, the preform materials or components expand or protrude less than half way through the apertures. The apertures 318, 320 are more commonly designed so that the expansion or protrusion of the preform materials or components through the apertures is less than about 40% through the apertures, less than about 30% through the apertures, or less than about 20% through the apertures. Ideally, the expansion or protrusion of the preform materials or components through the apertures is less than about 10% through the apertures, less than about 5% through the apertures, less than about 3% through the apertures, or even less than about 1% through the apertures. In the latter embodiments, the surface finish of the formed insulation is greatly improved since the expansion or protrusion of the preform materials into the apertures is essentially negligible. For fiber reinforced aerogel containing preforms, the apertures 318, 320 may be sized and/or configured based on the fiber length. For example, a ratio of an average length of fibers to an average diameter of apertures 318, 320 may range between about 3:1 and about 30:1 such that the materials or components of the preform are captured and maintained within the interior of the inner mold 302. Some individual components or ingredients of the perform, such as the aerogel particles, may have a size smaller than the apertures 318, 320. However, as discussed above, the components or ingredients may be evenly mixed and thus uniformly distributed in the perform such that the aerogel particles and/or other ingredients of relatively small sizes may be trapped or held within the combined binder and fibers (e.g., a mixture of coarse glass fibers and glass microfibers) without expanding or protruding into the apertures 318, 320 when pressed by the molds.

When the diameter of the apertures 318, 320 is relatively large, such as greater than about ¼ inches, bumps or dimples may be formed in the formed insulation. When the diameter of the apertures 318, 320 is less than or about ¼ inches, a substantialy smooth surface finish may be obtained, or minimal bumps or dimples may be formed in the molded insulation. When the diameter of the apertures 318, 320 is less than or about ⅛ inches, substantially no bumps or dimples may be formed in the molded insulation. Accordingly, an aperture size/diameter of less than or about ¼ inches allows for quick drying/curing and also leads to a substantial smooth surface finish. A substantial smooth surface finish may include some bumps or dimples formed on the surface of the insulation product, but the height of the bumps/dimples may be less than or about 1/16 inch, less than or about 1/32 inch, or less than or about 1/64 inch. In some embodiments, to further improve the surface finishing of the dried/cured insulation products, the inner surfaces of the inner mold 302 may be coated with a mold release treatment, such as a polished surface, polytetrafluoroethylene (PTFE) including Teflon®, non-stick coatings by ILAG, porcelain, etc. The mold release treatment may be permanent or semi-permanent. Temporary mold release spray on treatments, such as McLube®, may also be utilized. In some embodiments, a porous layer, such as a porous fabric layer, may be provided to cover the inner surfaces of the inner mold 302. The porous fabric layer may function as a release liner sheet, as well as bridging the apertures 318, 320 to reduce or substantially eliminate any bumps or dimples that may be formed, when a relatively large aperture size, such as greater than or about ⅛ inches, greater than or about ¼ inches, or greater than or about ½ inches, is implemented. In some embodiments, the porous fabric layer may include a polytetrafluoroethylene (PTFE) fabric layer. The thickness of the porous fabric layer may range between about 0.05 mm and about 0.5 mm.

As discussed above, the inner mold 302 includes a relatively light-weight construction for maintaining the shape and/or dimension of the pressed preform, and the outer mold 304 is configured to create the desired shape and/or dimension by pressing the preform contained in the inner mold 302. During this molding process, the outer mold 304 also imparts sufficient pressure to remove a substantial amount of water contained in the preform. Therefore, the outer mold 304 is commonly configured with sufficient weight and/or structural stiffness or rigidity to generate and impart sufficient molding pressure across its entire molding surfaces. In some embodiments, a ratio of the weight of the outer mold 304 to the weight of the inner mold 302 may range between about 2:1 and about 10:1, such as about 3.5:1, and the weight ratio of the outer mold 304 to the inner mold 302 may be greater than or about 2:1, greater than or about 3:1, greater than or about 5:1, greater than or about 7:1, or greater than or about 10:1 in various embodiments. For example, in some embodiments, the outer mold 304 may weigh over 100 lbs whereas a matching inner mold 302 may only weight about 15 to 50 lbs. In some embodiments, one or both of the mold halves of the outer mold 304 may further include one or more reinforcing ribs 340.

To facilitate the removal of water from the preform by the outer mold 304, the mold assembly 300 may include a pair of mesh inserts 350, 352. As schematically illustrated in FIG. 3B, one mesh insert 350 is positionable between an upper mold 342 of the outer mold 304 and the upper mold 310 of the inner mold 302, and the other mesh insert 352 is positionable between a lower mold 344 of the outer mold 304 and the lower mold 312 of the inner mold 302. The mesh inserts 350, 352 may be shaped to substantially conform to the adjacent inner or outer surfaces of the adjacent mold halves 342, 310, 312, 344. The mesh inserts 350, 352 may be made of stainless steel wire cloth materials that possess good corrosion and abrasion resistance. Because the mesh inserts 350, 352 are not placed in the oven for drying/curing the preform, and thus are not subject to high temperature conditions, other materials including plastic mesh, fabric mesh, or any other mesh or porous layer that can hold up to and withstand frequent use and/or maintain uniform and consistent pressure on the inner mold 302 during the molding process may be used. When stainless steel mesh inserts are used, the size of the openings of the mesh inserts 350, 352 may be about 0.1″, and the diameter of the wires forming the mesh may be about 0.065″, although other opening sizes and/or other wire diameters may be used for the mesh inserts 350, 352. In some embodiments, instead of or in addition to the mesh inserts 350, 352, channels or openings may be formed in the curved sections 346 of the outer mold 304 between the reinforcing ribs 340 to facilitate dewatering.

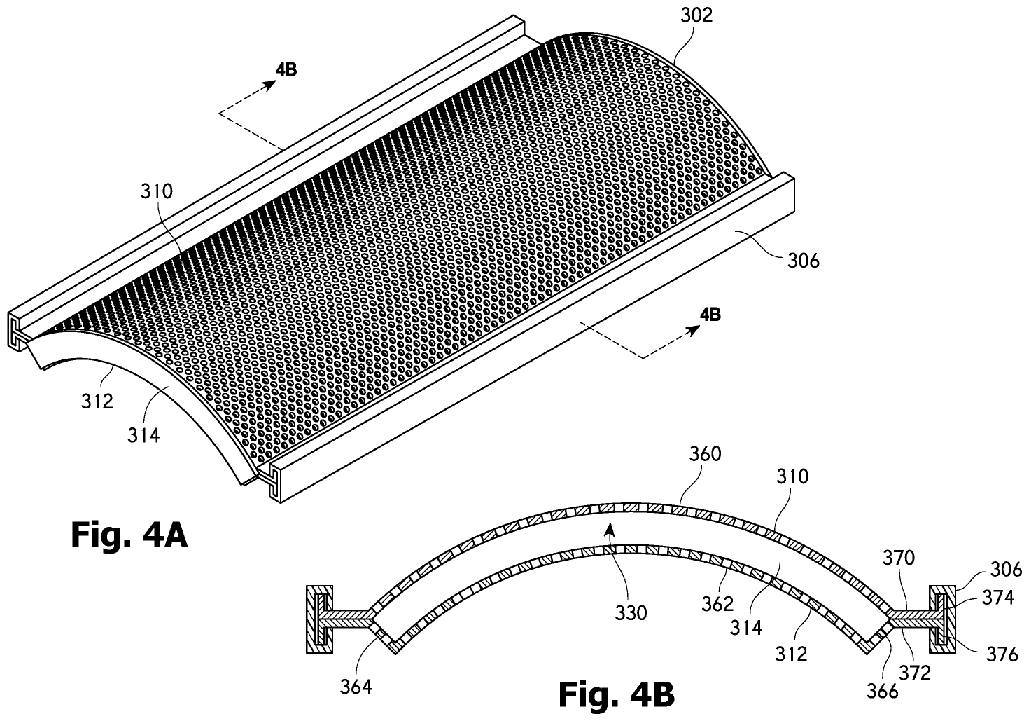

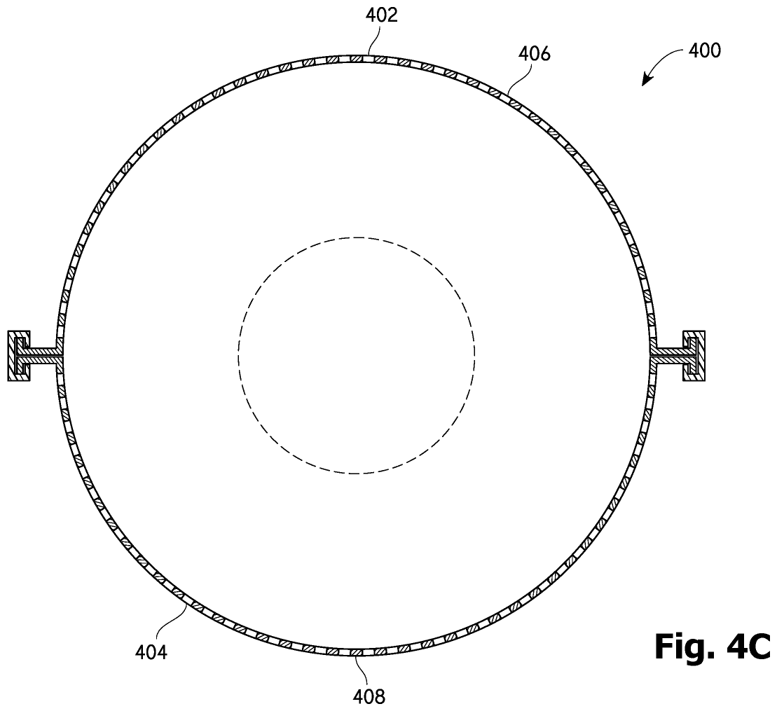

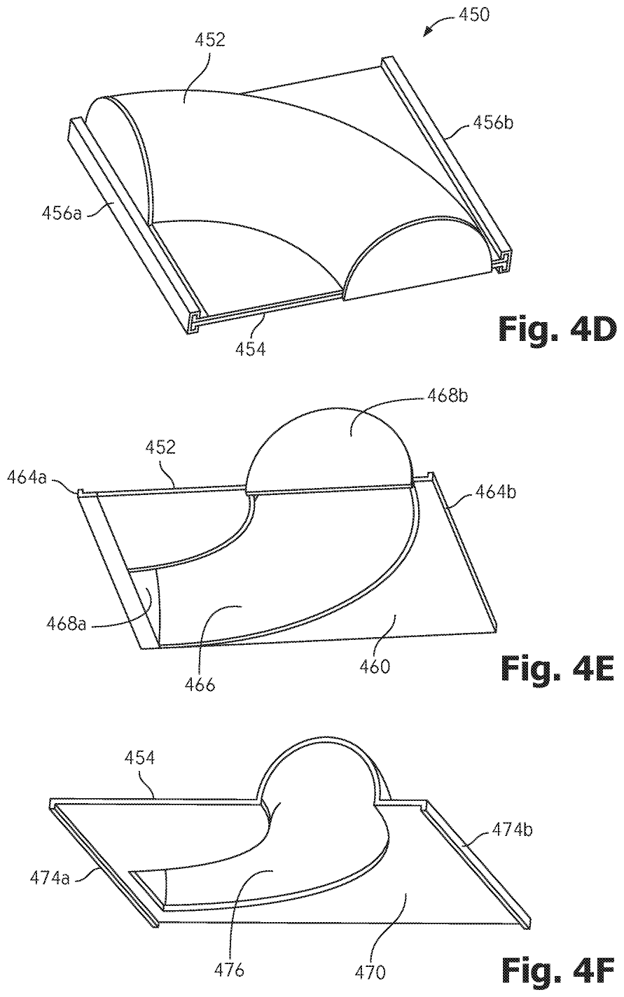

FIGS. 4A and 4B schematically illustrate the inner mold 302 in a closed configuration with the upper mold 310 and the lower mold 312 held together by the pair of clamp strips 306. As shown in FIG. 4B, the upper mold 310 and the lower mold 312 include lateral extensions 370, 372 that are configured to extend outside the outer mold 304 when the inner mold 302 is positioned inside the outer mold 304. Flanges 374, 376 may be formed at the end of each lateral extensions 370, 372 and may be configured to engage the pair of clamping strips 306, or other fastening mechanisms, for holding the upper mold 310 and the lower mold 312 together. While being clamped in the closed configuration, the inner mold 302 with the pressed preform contained therein (not shown in FIGS. 4A and 4B) may be placed in the oven for drying/curing the preform.

With reference to FIG. 4B, the upper mold 310 may include a curved section 360, and the lower molding half 312 may include a curved section 362 and two straight sections 364, 366. The two curved sections 360, 362, the two straight sections 364, and the longitudinal ends 314 of the lower molding half 312 collectively define the mold cavity 330 of the inner mold 302. The curved sections 360, 362 define two opposite major surfaces of the molded insulation, the two straight sections 364 define two opposite side surfaces of the molded insulation, and the two longitudinal ends 314 define another two opposite surfaces of the molded insulation. In some embodiments, at least one or both of the two curved sections 360, 362 may be perforated. In some embodiments, the two straight sections 364 may also be perforated. The lateral extensions 370, 372 and the flanges 374, 376 are typically not perforated in the embodiment shown for structural strength, although they may be perforated in other embodiments.

Although the figures illustrate that the lower mold 312 includes the two straight sections 360, 362, in other embodiments the upper mold 310 may include the two straight sections 360, 362, rather than the lower mold 312. In some embodiments, the two straight sections 364, 366 and the two longitudinal ends 314 may be positioned on the same mold half , which may allow a user to easily place the preform and/or other moldable material into the mold due to the two straight sections 364, 366, the two longitudinal ends 314, and the curved section functioning as a container or receptacle for the preform or other moldable material. In some embodiments, at least one of the straight sections 364, 366 and/or the longitudinal ends 314 may be positioned on the other mold half . For example, one of the two longitudinal ends 314 may be positioned on the upper mold 310 rather than on the lower mold 312. In such embodiments, a preform may be slid longitudinally onto the lower molding half 312 until the preforms contacts the sole longitudinal end 314 of the lower mold 312. Similarly, one of the two straight sections 364, 366 may be positioned on the upper mold 310 rather than on the lower mold 312. In such embodiments, a preform may be slid circumferentially onto the lower mold 312 until the preform contacts the sole straight section 364, 366 of the lower mold 312. Various other configuration of the upper mold 310 and/or the lower mold 312 may be implemented as desired.

The inner mold 302 may include a length as defined by the longitudinal extension of the curved sections 360, 362, a depth defined by the distance between the curved sections 360, 362, and a width defined as the arc length measured at the mid-point of the depth of the inner mold 302. Depending on the finished insulation product to be formed, a ratio of the length to the width of the inner mold 302 may be at least or about 1:1, at least or about 1.5:1, at least about or 2:1, at least or about 3:1, or greater, and the ratio of the width to the depth of the inner mold 302 may be at least or about 1:1, at least or about 2:1, at least about or 3:1, at least or about 4:1, at least or about 5:1, at least or about 10:1, at least or about 15:1, at least or about 20:1, or greater to produce insulation products of various shapes and/or sizes. In some embodiments, the length of the inner mold 302 may range between about 5″ to about 50″.

Although FIGS. 4A and 4B illustrate an inner mold 302 that is designed to form curved or contoured sections of insulation products, inner molds of various other shapes may be implemented for producing flat insulation products or other shapes, such as elbows, tees, reducers etc.

With reference to FIG. 4C, another exemplary inner mold 400 for making insulation products in a cylinder form is shown. The inner mold 400 includes an upper mold 402 and a lower mold 404. The upper mold 402 and the lower mold 404 each include a curved section 406, 408 in a half-cylinder shape. The curved sections 402, 404 of the upper mold 402 and the lower mold 404 define two portions of a continuous surface , such as two half cylindrical surfaces of a full cylindrical exterior . At least one of the curved sections 406, 408 is perforated and typically both curved sections 406, 408 are perforated. In some embodiments, the upper mold 402 and the lower mold 404 include lateral extensions and flanges, similar to those discussed above with reference to the inner mold 302 of FIG. 4B. The lateral extensions and flanges are configured for engaging side clamps to hold the upper mold 402 and the lower mold 404 together. In some embodiments, instead of being clamped together, one side of the upper mold 402 may be hinged to one side of the lower mold 404, and the other side of the upper mold 402 and the lower mold 404 may be clamped together.

The matching outer mold for the inner mold 400 is not shown, although it should be readily understood from the figures that the outer mold may include two cylindrical halves that when closed, define a cylindrical mold cavity for receiving therein the inner mold 400. Further, in some embodiments, a ventilated shaft (as indicated by the dash line in FIG. 4C) may be placed about the center of the inner mold 400 when the preform or other moldable material is placed inside the inner mold 400.

With reference to FIGS. 4D-4F, another exemplary inner mold 450 for making insulation products to insulate elbows in a pipe system is shown. The inner mold 450 includes an upper mold 452 and a lower mold 454. FIG. 4D illustrates a top perspective view of the upper mold 452 and the lower mold 454 in an assembled state, i.e., held together by a pair of side clamp strips or clips 456a, 456b. FIGS. 4E and 4F illustrate bottom perspective views of the upper mold 452 and the lower mold 454, respectively.

The matching outer mold for the inner mold 450 is not shown, although it should be readily understood from the figures and the description herein that the outer mold may include two halves each having an elbow shaped section. When the outer mold is closed, the outer mold may define an elbow shaped mold cavity for receiving therein the inner mold 450.

Referring back to FIGS. 4E and 4F, the upper mold 452 and the lower mold 454 may each include a substantially flat platform 460, 470 and two side flanges 464a, 464b, 474a, 474b that are configured to engage the side clamp strips 456a, 456b to maintain the upper mold 452 and the lower mold 454 in an assembled state. The upper mold 452 and the lower mold 454 may each include an elbow shaped section 466, 476 that may define the upper or exterior surface and the lower or interior surface, respectively, of the elbow shaped insulation to be formed. Although not shown in FIGS. 4D-4F, the elbow shaped sections 466, 476 may include perforation or apertures similar to those discussed above with reference to the inner mold 302 and/or the inner mold 400 to facilitate the drying/curing process.

The upper mold 452 may further include two end members 468a, 468b that may close the two semicircle openings of the elbow shaped section 466. When the upper mold 452 and the lower mold 454 are assembled, the end members 468a, 468b may also intersect the elbow shaped section 476 of the lower mold 454. Accordingly, the elbow shaped section 466 of the upper mold 452, the elbow shaped section 476 of the lower mold 454, and the end members 468a, 468b may collectively define the elbow shape of the insulation to be formed. As shown in FIG. 4D, the end members 468a, 468b may close the entire semicircle openings of the elbow shaped section 466 of the upper mold 452. With this configuration, the upper mold 452 may be used with different lower mold halves that may include a different radius than that of the lower molding half 454 shown in FIG. 4F to form insulation products of various thickness. In some embodiments, the end members 468a, 468b may also be perforated.

Although the elbow shaped sections 466, 476 of the inner mold 450 shown in FIGS. 4D-4F may define a 90° elbow, the elbow shaped sections 466, 476 may be configured with a 45° span to define a 45° elbow or any other suitable degree of span to form various curve insulation products. In some embodiments, instead of elbow shaped sections 466, 476, the upper mold 452 and the lower mold 454 may each include a toroidal shaped section, i.e., a 360° span to define a complete circle. The formed insulation may then be cut into segments that form 45° elbows, 90° elbows, or elbows of any other suitable degree of span. Although elbow or toroidal shaped molds and insulation products are described herein, the upper and low mold halves 452, 454 may include any shapes that may be formed on the respective platforms 460 470 to produce insulation products of various shapes or forms.

The various embodiments of the inner mold, as well as the mold assembly including the inner mold and the matching outer mold, provide many advantages over conventional molds. Because only the inner mold, which has less mold mass, is placed in the oven, it is significantly easier and quicker to heat up the molded material in comparison with conventional molds. The perforated inner mold also readily permits water, water vapor, or other fluids to escape and enables convective drying to occur, which greatly reduces the curing time of the insulation. Moreover, because only the inner mold may be tied up in the drying, curing, cooling and/or cleaning processes, mold costs can be minimized. Although only one pair of matching inner mold and outer mold are shown in FIGS. 3A-3C, multiple inner molds may be formed that are configured to work with a given outer mold such that multiple molded pieces can be formed sequentially using the same outer mold and each formed molded piece may be dried/cured simultaneously, thereby increasing production efficiency.

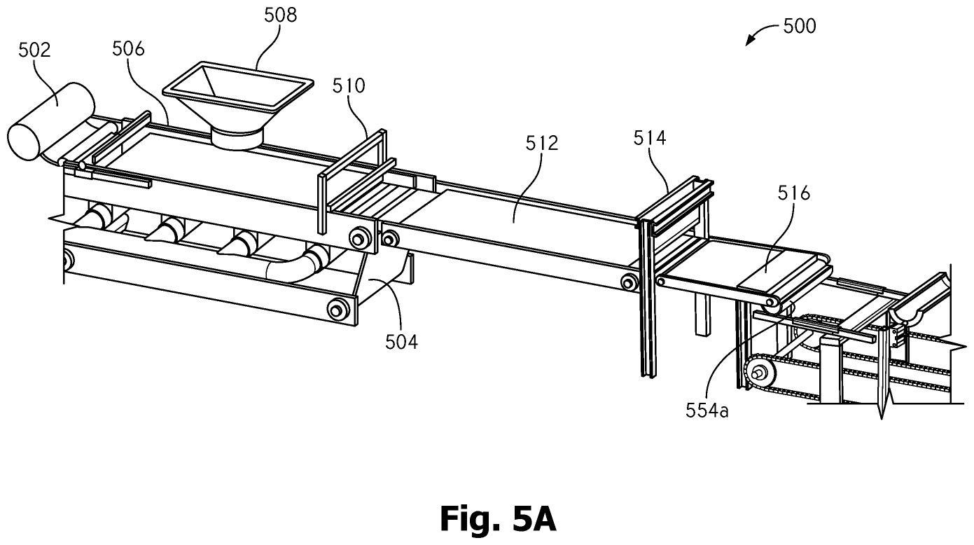

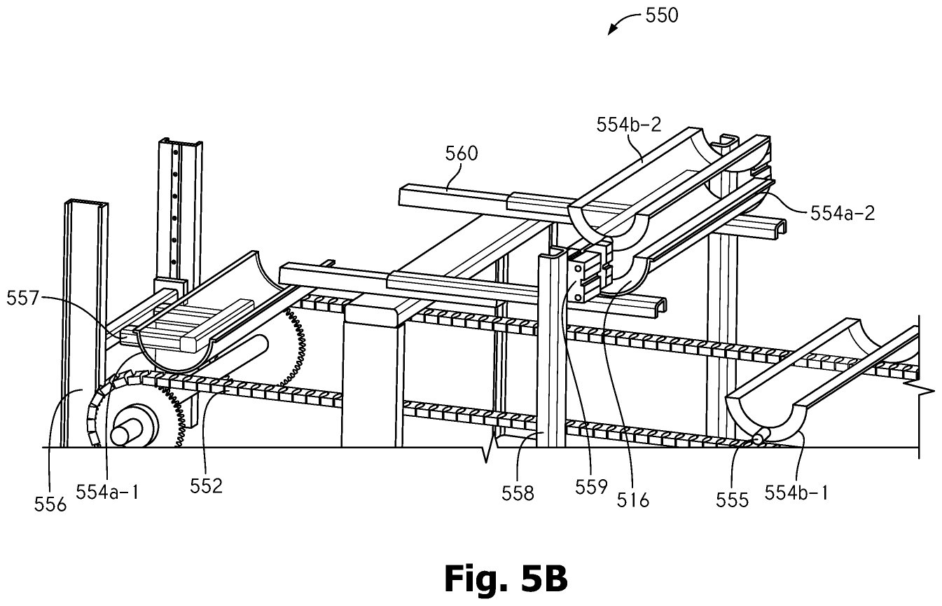

With reference to FIGS. 5A and 5B, an exemplary system 500 incorporating an embodiment of the inner mold described herein for producing insulation products is shown. During operation, a roll of a porous mat 502, such as a nonwoven fiber glass mat, may be fed onto a moving belt 504 and indexed into a forming box 506 to receive one or more moldable materials that may be dispensed by a feeder 508 or other dispensing tool. The moldable materials may include materials or components for forming the insulation products discussed above (e.g., a fiber reinforced aerogel containing insulation). The porous mat 502 forms a light-weight carrier mat for the moldable material and may become an integral part of the insulation product once the molded piece dries and cures, providing the finished insulation product with a reinforced surface, which may be relatively stiff . In some embodiments, the forming box 506 may include a size adjusting mechanism 510 so that varied lengths and/or widths of the forming box 506 may be achieved. The forming box 506 may include a porous bottom, through which vacuum or suction may be applied to remove at least some of the water content in the moldable material. Once dewatered, the moldable materials forms a blanket 512, which is subsequently indexed onto another moving belt and cut by a chopper 514 into insulation preforms 516 of appropriate sizes. Each of the preforms 516 may then be fed into a molding half 554a, or more specifically, a molding half of an inner mold similar to those described herein, and take the shape of the molding half 554a.

With further reference to FIG. 5B, the system 500 may further include a molded piece assembly line 550. The assembly line 550 may include a moving chain 552 that transports cooperating mold halves 554a, 554b in an alternating order. At least one or both of the cooperating mold halves 554a, 554b may be perforated. However, the perforation is not shown in FIG. 5A; rather, the mold halves 554a, 554b are shown transparent to better illustrate other structures and components in the assembly line 550. The assembly line 550 further includes a first elevating system 556, a second elevating system 558, and a pair of transport arms 560 that are configured to move between the first and second elevating systems 556, 558. The first elevating system 556 may include arms or forks 557 that are configured to lift one of the cooperating mold halves or a lower mold 554a-1 to the proximity of the moving belt carrying the cut preforms 516 so that a preform 516 may be laid into the lower mold 554a (see FIG. 5A). Once the mold 554a is loaded with a preform 516, the transport arms 560 may move towards the first elevating system 556 and slide under the lower mold 554a loaded with the preform 516. The first elevating system 556 may then lower the loaded lower mold 554a onto the transport arms 560. The transport arms 560 may then move towards the second elevating system 558 with the loaded lower mold 554a.

The second elevating system 558 is configured to lift the other one of the cooperating mold halves or an upper mold 554b-2 above the transport arms 560 before the transport arms 560 move a loaded lower mold 554a-2 to the second elevating system 558. The second elevating system 558 may further include a pair of engagement members 559 that are configured to engage protrusions 555 formed on the circumferential ends of the upper mold 554b. The engagement or coupling between the engagement members 559 and the protrusions 55 may also limit or prevent rocking motion of the upper mold 554b to ensure alignment between the upper and lower mold halves 554a, 554b. Once a loaded lower mold 554a-2 is moved to the second elevating system 558 and under the upper mold 554a-2, the second elevating system 558 may lower the upper mold 554a-2 onto the preform 516 and the lower mold 554b-2. The combined mold halves 554a, 554b may then be moved to a matching outer mold to be further compressed by the outer mold to mold or form the preform 516 into a desired shape and/or dimension. The mold halves may then be clamped together, removed from the outer mold, and placed into an oven to dry and cure the preform 516 into an insulation product. Although in FIG. 5B, the mold halves 554a, 554b are disposed on the moving chain 552 so that they curve downwardly, in other embodiments, the mold halves 554a, 554b may be disposed on the moving chain 552 so that they curve upwardly.

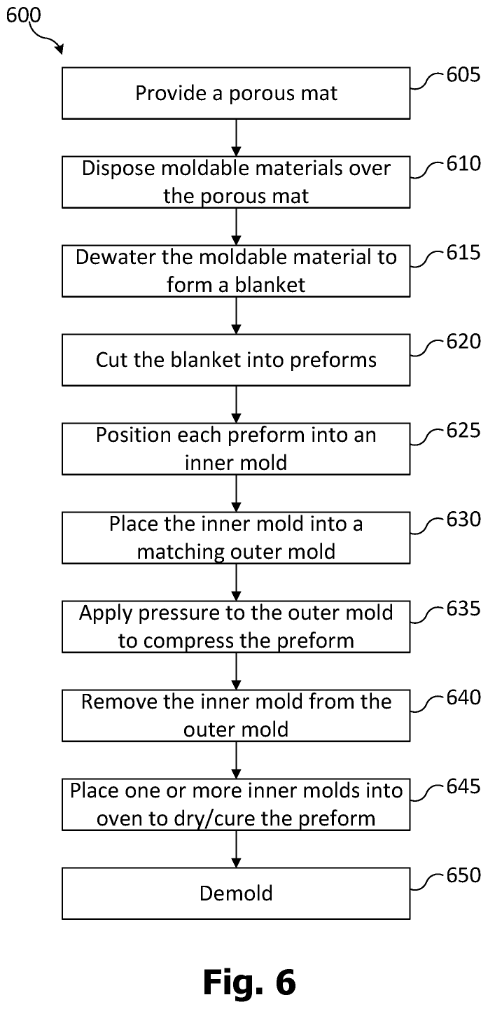

Referring now to FIG. 6, illustrated is a method 600 of forming an insulation product using one of the mold assemblies described above with reference to FIGS. 3A-3C and 4A-4F. The method may be performed using all or some components of the system 500 described above with reference to FIGS. 5A and 5B. The method may begin at block 605 by providing a porous mat, such as a nonwoven fiber glass mat. The provision of the porous mat may be similar to the feeding of the porous mat 502 onto the forming box 506 discussed above with reference to FIG. 5A. At block 610, one or more moldable materials, such as materials or components for forming a fiber reinforced aerogel containing insulation, are disposed over the porous mat. At block 615, the moldable materials carried by the porous mat is dewatered, for example, by using a dewater table or a forming box similar to the forming box 506 discussed above. The dewatered moldable materials and the porous carrier mat form a blanket. At block 620, the blanket may be cut to provide preforms of various appropriate sizes, if needed. At block 625, each preform is positioned into an inner mold, similar to one of the inner molds discussed above with reference to FIGS. 4A-4F. At block 630, the inner mold is placed into a matching outer mold. At block 635, pressure is applied to the outer mold such that the outer mold imparts pressure onto the inner mold to compress the preform positioned within the inner mold into a desired shape and/or dimension. The compression also removes a substantial amount of fluid content from the preform. At block 640, the inner mold that contains the compressed preform is removed from the outer mold. At block 645, one or more inner molds that each contain a compressed preform may be placed into an oven in which each preform is dried (e.g., reducing/removing moisture, water, or other fluids by evaporation) and the binder of the preform is cured to bond the components of the preform together to form an insulation product, such as the fiber reinforced aerogel containing insulation described herein. Because the inner mold includes perforations that are configured to readily allow moisture, water, water vapor, or other fluids from the fiber reinforced insulation preform to pass through or escape from the inner mold, the drying/curing time may be reduced in comparison with conventional molds. Further, because the perforations are configured to substantially prevent fibers from the fiber reinforced insulation preform from passing through the inner mold, a substantially smooth surface finish of the formed insulation may be achieved, which may greatly improve the structural integrity and/or strength of the formed insulation. At block 650, the dried and cured insulation products are removed from the inner molds. Conventional molds typically have a significant material mass that must be cooled for a period of time before reused. The light-weight construction of the inner molds may allow the inner molds to be reused without requiring an extended cooling time, or in some embodiments, a cooling step may be omitted entirely.

While several embodiments and arrangements of various components are described herein, it should be understood that the various components and/or combination of components described in the various embodiments may be modified, rearranged, changed, adjusted, and the like. For example, the arrangement of components in any of the described embodiments may be adjusted or rearranged and/or the various described components may be employed in any of the embodiments in which they are not currently described or employed. As such, it should be realized that the various embodiments are not limited to the specific arrangement and/or component structures described herein.

In addition, it is to be understood that any workable combination of the features and elements disclosed herein is also considered to be disclosed. Additionally, any time a feature is not discussed with regard in an embodiment in this disclosure, a person of skill in the art is hereby put on notice that some embodiments of the invention may implicitly and specifically exclude such features, thereby providing support for negative claim limitations.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A mold for forming a fiber reinforced insulation product, the mold comprising:
an upper mold; and
a lower mold, wherein the upper mold and the lower mold are coupleable to define a mold cavity for receiving therein a fiber reinforced insulation preform, wherein the upper mold includes a plurality of apertures that are configured to allow moisture from the fiber reinforced insulation preform to pass through the upper mold while substantially preventing fibers from the fiber reinforced insulation preform from passing through the upper mold such that the fiber reinforced insulation preform dries and cures to form the fiber reinforced insulation product, and wherein the plurality of apertures collectively define an open area of at least 20% of an inner surface area of the upper mold that contacts the fiber reinforced insulation preform.

2. The mold of claim 1, wherein the plurality of apertures are disposed across substantially the entire inner surface area of the upper mold that contacts the fiber reinforced insulation preform.

3. The mold of claim 1, wherein the lower mold includes a plurality of apertures that are configured to allow moisture from the insulation preform to pass through the lower mold while substantially preventing fibers from the fiber reinforced insulation preform from passing through the lower mold.

4. The mold of claim 3, wherein the plurality of apertures of the lower mold collectively define an open area of at least 20% of an inner surface area of the lower mold that contacts the fiber reinforced insulation preform.

5. The mold of claim 3, wherein the plurality of apertures are disposed across substantially the entire inner surface area of the lower mold that contacts the fiber reinforced insulation preform.

6. The mold of claim 1, wherein a ratio of a combined weight of the upper mold and the lower mold to a volume of the mold cavity ranges between about 80 pcf and about 280 pcf.

7. The mold of claim 1, wherein the upper mold has a thickness between about 0.075″ and about ¼″.

8. The mold of claim 1, wherein the upper mold has a substantially uniform thickness.

9. The mold of claim 1, wherein an average diameter of each aperture of the plurality of apertures is less than or about 0.5″ such that the fiber reinforced insulation preform protrudes no more than 10% into the plurality of apertures.

10. The mold of claim 1, wherein a ratio of an average length of fibers in the fiber reinforced insulation preform to an average diameter of the plurality of apertures is at least about 3:1 such that the fiber reinforced insulation preform protrudes no more than 10% into the plurality of apertures.

11. The mold of claim 1, wherein when coupled together, the upper mold and the lower mold define a cylindrical mold cavity.

12. The mold of claim 1, wherein the mold cavity defines one of a cylinder, a section of a cylinder, an elbow, or a substantially flat blank.

13. A mold assembly, comprising:
the mold of claim 1;
an additional mold configured to removably receive therein the mold of claim 1, wherein an inner surface of the additional mold substantially conforms to an outer surface of the mold of claim 1.

14 . A wet-laid system for making fiber reinforced insulation preforms for fitting into the mold of claim 1.

15. A mold assembly for making a fiber reinforced insulation product, the mold assembly comprising:
an outer mold defining a first mold cavity;
an inner mold configured to be removably received inside the first mold cavity, wherein the inner mold defines a second mold cavity configured to receive a fiber reinforced insulation preform having a first shape, and wherein the inner mold is configured to surround substantially all sides of the fiber reinforced insulation preform so as to form the fiber reinforced insulation preform into a second shape, and wherein when the inner mold is received inside the outer mold, an inner surface of the outer mold is configured to contact substantially an entire outer surface of the inner mold so as to impart pressure onto the inner mold, and the inner mold is configured to impart the pressure imparted by the outer mold onto the fiber reinforced insulation preform received inside the second mold cavity to form the fiber reinforced insulation preform into the second shape.

16. The mold assembly of claim 15, wherein the inner mold includes two mold halves, and wherein at least one of the mold halves is perforated to allow moisture from the fiber reinforced insulation preform to pass through the at least one of the mold halves while substantially preventing fibers from the fiber reinforced insulation preform from passing through the at least one of the mold halves.

17. The mold assembly of claim 15, wherein a ratio of a weight of the outer mold to a weight of the inner mold is about 3.5:1.

18. A method for making a fiber reinforced insulation product, the method comprising:
providing a fiber reinforced insulation preform;
positioning the fiber reinforced insulation preform into an inner mold;
positioning the inner mold into an outer mold;
applying pressure to the outer mold such that the outer mold imparts pressure onto the inner mold to compress the fiber reinforced insulation preform positioned within the inner mold;
removing the inner mold from the outer mold;
drying the fiber reinforced insulation preform positioned within the inner mold; and
curing a binder of the fiber reinforced insulation preform;
wherein the inner mold includes a plurality of apertures that are configured to allow moisture from the fiber reinforced insulation preform to pass through the inner mold while substantially preventing fibers from the fiber reinforced insulation preform from passing through the inner mold such that the fiber reinforced insulation preform dries and cures to form the fiber reinforced insulation product.

19. The method of claim 18, wherein the inner mold comprises a first mold half and a second mold half, and wherein the first mold half or the second mold half includes the plurality of apertures.

20. The method of claim 18, wherein an outer surface of the inner mold substantially conform to an inner surface of the outer mold.
